(19) United States
(12) Patent Application Publication
(10) Pub. No.: US 2002/0080417 A1
(43) Pub. Date: Jun. 27, 2002

(54) Method for verifying the authencity of an electronic document

(76) Inventor: Douglas B. Quine, Bethel, CT (US)

Correspondence Address: Pitney Bowes Inc., Intellectual Property & Technology Law Department, 35 Waterview Drive, P.O. Box 3000, Shelton, CT, 06484, US

(21) Appl. No.: 09/748,994

(22) Filed: Dec. 27, 2000

(51) Int. Cl. H04N 1/00

(52) U.S. Cl. 358/407; 358/402

(57) ABSTRACT

A method for verifying the authenticity of information communicated between a first communication device and a second communication device via a communication network is disclosed. The invention provides for and verifies the authenticity of the communicated information by calculating a checksum of the transmitted information while encrypting the same. The encrypted checksum is convolved with the content of the information intended to be transmitted (document data), thus producing convolved data. The convolved data is transmitted by said first communication device via a communication network to the second communication device. The second communication device is configured to decrypt the encrypted checksum and compute a checksum of the data/document received by such second communications device. Decrypted checksum data is compared with the checksum computed by the second communications device to verify the authenticity of the data/document received by the second communication device. In the event of a mismatch, a recipient at the second communications device is alerted that the received data/document has been tampered with. A recipient may also receive documents or data as an e-mail attachment which may be viewed using appropriate software configured to display such data or documents.

### FIELD OF THE INVENTION

The present invention relates to a method for verifying the authenticity of information communicated between two communications devices whether they are directly connected or connected via a communications network. More specifically, it relates to a method for verifying the authenticity of documents communicated via a facsimile device to a recipient who receives such communicated information by means of a (a) dedicated fax device having storage capability; or (b) a computer system with facsimile communications capability; or (c) by relaying the facsimile information through e-mail delivery.

### BACKGROUND OF THE INVENTION

In the field of communications, facsimile machines are being used by an increasing number of companies and individuals for rapid delivery of information. Further, facsimile machines have become a standard office device and an efficient means to insure rapid document transmission. With the increased utilization of facsimile machines has come the potential for tampering with confidential information by facsimile transmission. Not only unintentional losses, but also intentional tampering of confidential documents may occur as sensitive documents are viewed and tampered by persons who have access to facsimile machine but who are not cleared to modify the content of the documents.

Further, since the nature of facsimile communication involves viewing or printing transmitted data at a location remote from the origin, it is difficult to confirm the validity of the received data. The viewed or printed data appears as an “original print” of the transmitted data, and any information altered in transit or before display cannot be ascertained by a mere close examination of the received fax document.

It is also known that the material or information on the facsimile media that is being transmitted is subject to being viewed and/or tampered by someone other than the intended party at the receiving end of the operation. In the case of confidential information, it is desirable to include some means of identification in order to determine if the confidential document has been tampered with at the transmission site, or during transmission and prior to the receipt of the document by the recipient. It is further desirable to alert a recipient if in fact a confidential document has been tampered with by modifying the contents of the document.

One solution may be to provide a dedicated facsimile machine at each sensitive location with a code access for transmission and reception. This technique not only increases office complexity and cost, but it is also not effective as there is a possibility that access codes may quickly become known within an office. This approach also precludes receipt of information at multiple locations and through multiple system types—an essential feature of the widely available facsimile technology.

U.S. Pat. No. 5,029,901 to Dotson et al. discloses a confidential information bearing article having a cover sheet adhered to a base sheet which provides hidden confidential information to a recipient. This invention uses camouflage, obscuring, and reflectivity increasing coating effects on opaque paper media in order to prevent the disclosure of confidential information.

U.S. Pat. No. 4,941,685 to Anderson discloses a multiple part facsimile form with a first form part having pre-recorded information thereon and overlying a second form part in order to protect the disclosure of confidential information.

U.S. Pat. No. 6,025,931 to Bloomfield relates to the field of communications associated with the communication of facsimile messages and associated with combining facsimile delivery and electronic delivery.

None of the above prior art systems provide for authenticating documents transmitted by an originating device to a destination device, by computing a checksum of the transmitted document, encrypting the same, decrypting the encrypted checksum at the destination device, computing a checksum for the data received at the destination device, and comparing the decrypted checksum with the checksum calculated at the destination device in order to verify the authenticity of the received document.

Furthermore, prior-art references fail to alert a recipient, at a destination device, in the event that a received document has been tampered with. Based on the foregoing, it should be appreciated that there has arisen a need to provide a system and method to verify the authenticity of documents transmitted from an originating device and received at a destination device in a simple and cost-effective manner.

### SUMMARY OF THE INVENTION

Accordingly, the present invention is directed to a method for verifying the authenticity of information conveyed via a physical or electronic document and communicated between a first communication device and a second communication device, the information being transmitted via a communications network.

The present invention verifies the authenticity of the received documents by computing an encrypted checksum of the document transmitted and comparing a decrypted checksum of the document received at the destination device with the encrypted checksum value calculated at the originating device.

In one aspect, the present invention is directed to a system for authenticating information communicated over a communications system. The system comprises an originating device which includes means for generating data representative of data received by the originating device and a means for computing the checksum of the data received by the originating device. The originating device further includes means for encrypting the computed checksum, thus generating an encrypted checksum data. Means for convolving the representative data and the encrypted checksum data is also provided at the originating device in order to produce convolved data which is transmitted by the originating device to a destination device.

The destination device includes means for decrypting the encrypted checksum data and comparing the decrypted checksum data with the checksum data computed by the destination device in order to verify the authenticity of information received by the destination device. The destination device further includes means for alerting a recipient at the destination device in the event of a mismatch between the decrypted checksum data and the checksum data computed for document received by the destination device.

In one exemplary embodiment, the originating and destination devices comprise of a digital facsimile apparatus capable of rasterizing input data by physically scanning a document, wherein the rasterized data is created at the origin and transmitted to a destination. In another exemplary embodiment, the originating device is a computer system with communication capability and wherein appropriate communication software is installed in the computer system for facilitating communication with a destination device. The computer system further comprises means for rasterizing the scanned image for transmission in accordance with known facsimile protocols to a another facsimile enabled computer system or dedicated facsimile device.

In each instance, the present invention is directed to a method of authenticating information communicated between a first communication device and a second communication device, the information being transmitted via a communications network. In this method, the first communication device receives input data (physical or electronic) and generates information in a facsimile format. In addition to generating information in facsimile format, the first communication device also calculates a checksum of the input data and encrypts the same to generate an encrypted checksum data corresponding to the received input data.

Information generated in the facsimile format is convolved with the encrypted checksum data and transmitted to a destination device. The encrypted checksum data is decrypted and compared with the checksum data calculated at the originating device in order to verify the authenticity of the facsimile data received at the destination device. The method further comprises alerting a recipient at the destination device in the event of a mismatch between the decrypted checksum data and the checksum data computed by the destination device for a document received at the destination device.

In yet another exemplary embodiment, the present method further includes converting [step 240, FIG. 2A] the facsimile data to a format which can be embedded within or attached to an e-mail or electronic-mail format for further transmission, through the e-mail or electronic-mail network or Internet, to the ultimate recipient. Further, configuring an e-mail or electronic-mail system for receiving and displaying or printing the decrypted checksum along with the received input data, thereby alerting a recipient regarding the authenticity of the received input document.

### BRIEF DESCRIPTION OF THE DRAWINGS

A more complete understanding of the present invention may be had by reference to the following Detailed Description when taken in conjunction with the accompanying drawings wherein:

FIG. 1. depicts a prior art facsimile communication system associated with combining facsimile and electronic delivery of messages.

FIG. 2A illustrates a high level implementation of the preferred embodiment of the present invention wherein a facsimile apparatus is used as an originating device.

FIG. 2B illustrates a high level implementation of the preferred embodiment of the present invention wherein a computer system is used as an originating device.

FIG. 3A illustrates a process overview for security verification for an intelligent digital facsimile apparatus.

FIG. 3B illustrates a process overview for security verification of a document received by a computer system which includes (i) a facsimile communication system and related software or (ii) an e-mail or electronic messaging system with e-mail fax viewer software.

### DETAILED DESCRIPTION OF THE DRAWINGS

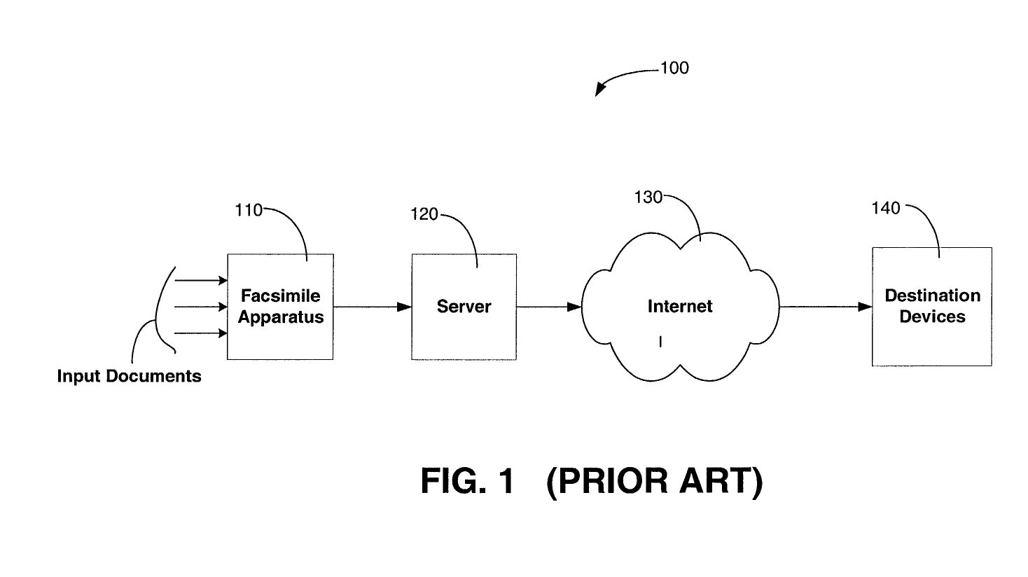

In the drawings, like or similar elements are designated with identical reference numerals through the drawings, and the various elements depicted are not necessarily drawn to scale. Referring now to FIG. 1, there is shown a prior-art general conceptual diagram of an existing facsimile apparatus that combines facsimile and e-mail/electronic-mail delivery of information.

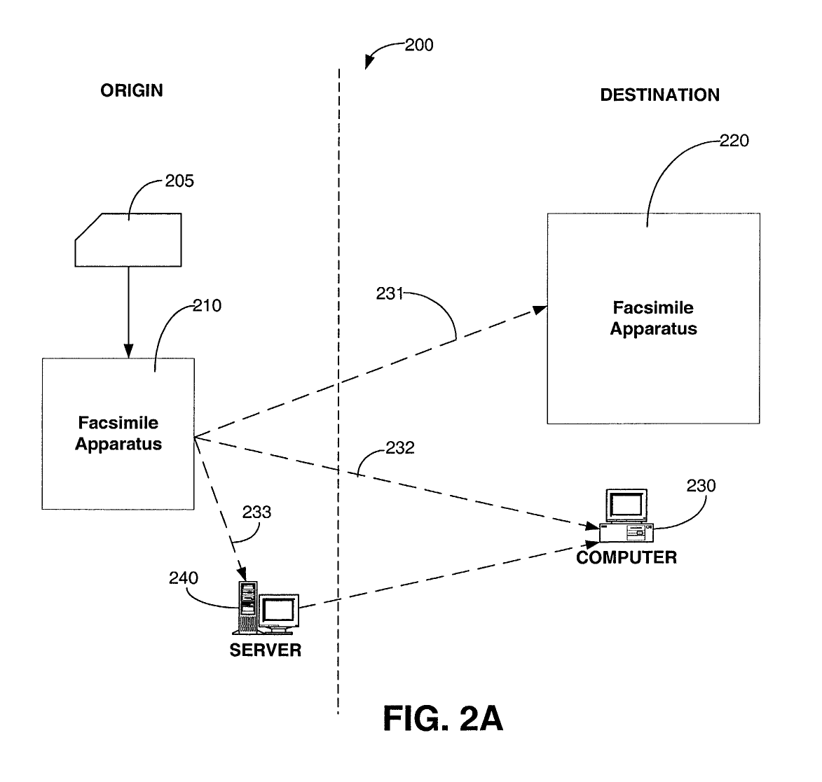

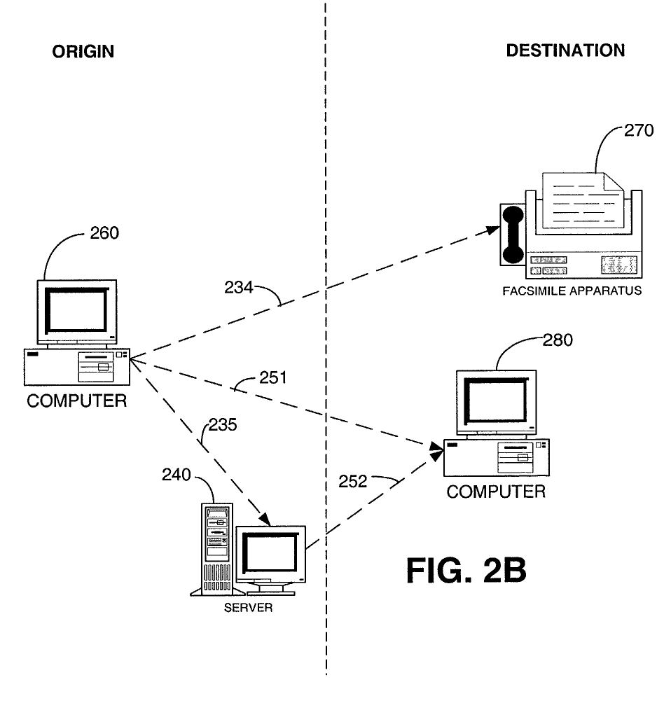

As illustrated in a presently preferred embodiment of the SecureFax system of the present invention as in FIG. 2, the SecureFax system comprises an originating device as represented in box 210 which is shown to be facsimile apparatus. In another embodiment, box 210 may be substituted by a computer system 260 comprising a communication means with appropriate communication software installed on the computer system 260. The facsimile apparatus 210 may be an analog facsimile unit or a digital facsimile unit. Facsimile apparatus 210 is provided with the capability to scan an original input document 205 and covert the same into a digitalized file format. Furthermore, the facsimile apparatus 210 is provided with a capability to calculate a checksum of the original input document 205, and encrypt the same prior to transmission to one of a plurality of destination devices 220, 230 as illustrated in FIG. 2A.

Checksum of a document 205 may be determined using any of the known checksum algorithms. These algorithms are used to obtain a mathematical value derived from the original data which changes when that original data is altered. Simple checksums (sum of all data values) can be defeated by symmetrical manipulations of the data (add x at one point and subtract x from another point) whereas more complex checksum algorithms may involve computations based upon rows, columns, and other data transformations that make undetected alternations to the data impossible. These methods of computing a checksum are shown only to be illustrative. Likewise, once the checksum of document 205 is computed, any known encryption method may be used to encrypt the checksum. Some examples of data encryption standards include Secure Hash Algorithms (SHA), RSA (Rivest, Shamir, Adelman), to name a few. One skilled in the art would appreciate that there may be other ways of computing a checksum and encryption of a document. Thus, the present invention is not intended to be restrictive of computing checksum and encryption of a document.

The checksum as discussed above represents a value computed from the original image data, i.e., from the data representing an original document. One skilled in the art would appreciate that it is possible to calculate other alternatives such as “checkmultiply”, “checkdivide”, “checksubtract”, and other forms such as “digital signature” or a “facsimile run-length encoded data stream” in order to represent the original data of a document. Therefore, the present invention should not be restricted to include “checksum” of the original data, rather is envisioned to cover all other mathematical values computed to represent the original data.

The facsimile apparatus 210 further comprises a system for convolving the original input data converted into a digital file format and the encrypted checksum data in order to produce a convolved data for transmission to one or more of destination devices 220, 230. It should be appreciated that the data in the digital file format and the convolved data for transmission conform to the standard format, for example CCITT, necessary for facsimile communication of data.

Thus, the convolved data may be transmitted via communication links 231, 232, or 233 to destination devices 220, 230, 240 respectively. It is quite possible that transmission may take place only to destination facsimile apparatus 220 by means of a communication link 231. It is also quite possible to have simultaneous transmission to all of the destination devices via their respective communication links. Each of the communication links 231-233, may be a wireline or wireless link. It is also quite possible each of the communication links 231-233 may represent a combination of links leading to a local exchange carrier (LEC) from the origin and then a global communication network. One skilled in the art would appreciate that a significant number of variations of routing a signal may be possible from an originating device 210 to one or more of destination devices as illustrated in FIG. 2A. Therefore, the present invention is not restrictive of a specific way of routing a call, and is intended to cover all known means of transmitting a signal from an originating point to a destination point, such known means of transmission include, for example, wireline or wireless links, or a combination of both.

A receiving/destination facsimile apparatus 220 is capable of receiving the convolved data transmitted by the facsimile apparatus 210. Facsimile apparatus 220 is capable of performing all the operations performed by facsimile apparatus 210, but in reverse order in order to retrieve the data transmitted by facsimile apparatus 210. Thus, facsimile apparatus 220 includes the capability to decrypt the encrypted checksum data and compare the decrypted checksum data against the checksum data calculated by facsimile apparatus 220 on the destination side. In the event of a mismatch, the facsimile apparatus 220 includes capability to alert a recipient of the transmission, at the destination side, about the mismatch of the checksum data. One form of indicating a recipient would be by placing a large “X” mark on a portion of the document received by the facsimile apparatus 220, the document representing original document data transmitted from facsimile apparatus 210 at the origin.

As illustrated in FIG. 2A, it should be appreciated that a receiving apparatus need not be a facsimile apparatus, per se. It could be a computer system 230 equipped with appropriate communication system and installed with relevant software necessary to transmit and receive information in facsimile format or in some other format with an appropriate viewer software. The computer system 230 further includes appropriate software for decrypting the encrypted checksum performed by the facsimile apparatus 210 at the origin. Thus, the computer system 230 performs an integrity check of the document, transmitted by the facsimile apparatus 210, by comparing the decrypted checksum with the checksum value computed by computer system 230 and alerts the recipient of the document, for example, by means of a message and/or a prominent mark upon the displayed document, in the event of a mismatch in the comparison.

Document 205 transmitted from the origin may be displayed by the computer system 230 after performing the necessary integrity checks as shown above. The received document may also be printed or processed subsequent to reception by the computer system 230 by interfacing a device compatible with the computer system 230. As noted earlier, it is not per se necessary that the transmission apparatus at the origin be a facsimile apparatus. It could be a computer system 260 as illustrated in FIG. 2B, the computer system 260 capable of performing all the functions of a facsimile apparatus 210.

Furthermore, the convolved data, generated by the facsimile apparatus 210, may be transmitted to a server 240 which receives and stores the convolved data (i.e., the encrypted checksum data and the data representing the original input document). The server system 240 is further configured to convert the received convolved data into a format that conforms to an e-mail service, i.e., the convolved data may be modified into a format which may be sent as an attachment to an e-mail to an intended recipient. Thus, the database server 240 further comprises a communication system capable of initiating an e-mail message to an intended recipient, the e-mail message including the received convolved data as an attachment. A recipient at a destination, a user of computer system 230 as illustrated in FIG. 2A, may view the e-mail message along with the attachment. The database server 240 may also be capable of verifying the integrity of the document received by decrypting the received encrypted checksum data and comparing the checksum of the original data with the decrypted checksum data. Similar to the alerting feature of computer system 230, the database server 240 may also include capability to activate similar feature.

It is to be understood that FIG. 2 is merely an illustrative example to more clearly explain the operation of the SecureFax system of the present invention. It should, however, not be construed as a limiting example of the present invention. Therefore, depending on the requirement of whether the originating and destination apparatuses need be a facsimile system or a computer capable of performing facsimile functions such relevant devices may be used. Furthermore, depending on the format in which an original document transmitted by an originating apparatus is intended to be received, appropriate interfaces may be inserted into the SecureFax system of the present invention in order to achieve the desired purpose. For example, if a recipient intends to receive a document as an e-mail attachment, an originating device, such as facsimile apparatus 210 or computer system 260, forwards a representative data of the original data to an intermediate database server 240 for processing. A recipient user at a computer system 230 communicates with the database server 240 to view the original document.

Further, transmission of data from an originating device to a destination device may be performed using wireless or wireline services. Thus, the devices at the origin and destination may be varied depending upon the requirements of a user. Similarly, the mode of communication may also be changed depending on the convenience and requirements of a user.

FIG. 2B illustrates a high level implementation of the preferred embodiment of the present invention wherein a computer system is used as an originating device. The computer system 280, as explained earlier, is capable of receiving digitalized input of an original document. The computer system 260 is also capable of rasterizing (electronically scanning for conversion to facsimile format) an electronic document intended to be transmitted to a destination device 270 or 280. The system details and operation of the computer system 280 is similar to the details and operation of computer system 230 discussed with respect to FIG. 2A as above. Similarly, the functional details of facsimile apparatus 270 and is similar to the functional details of facsimile apparatus 220 as illustrated in FIG. 2A. In that sense, FIG. 2B is just another embodiment of the SecureFax system as disclosed and described in FIG. 2A.

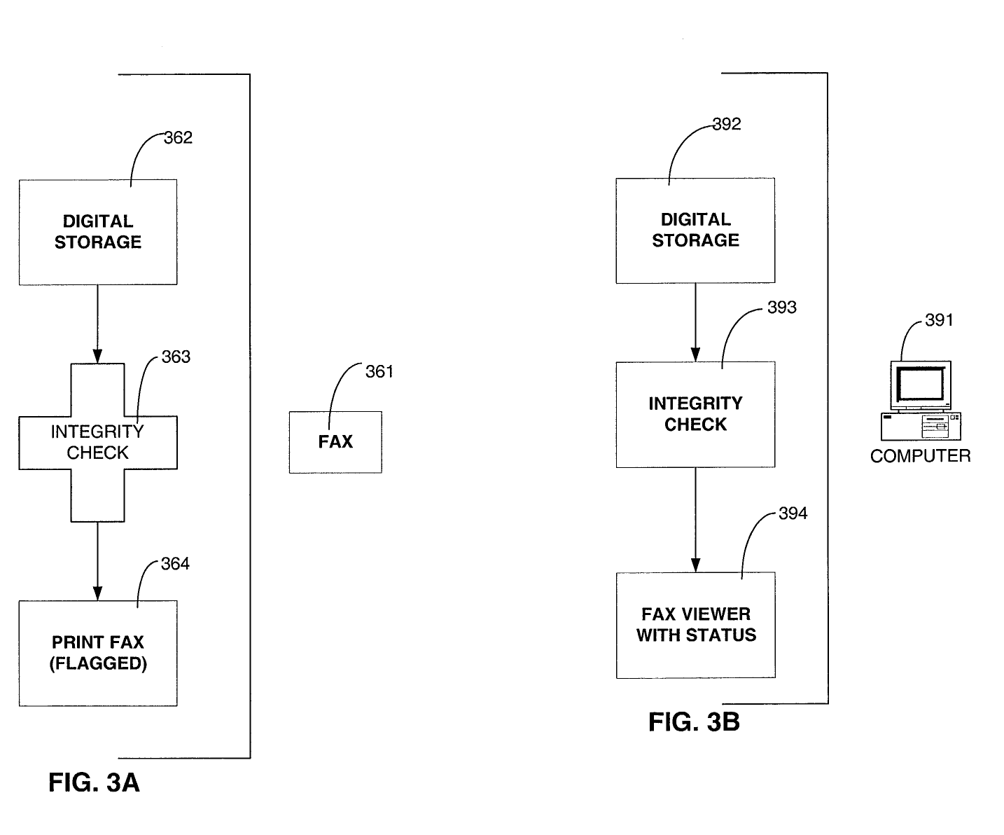

Referring now to FIG. 3A, there is shown a process overview for the security verification performed by an intelligent digital facsimile apparatus 361. It should be noted that the digital facsimile apparatus 361 is functionally similar to the facsimile apparatus 220 as represented in FIG. 2A, and facsimile apparatus 270 as represented in FIG. 2B. Digital data transmitted by an originating device, such as facsimile apparatus 210 or computer system 260, is received and stored in digital storage 362 of the facsimile apparatus 361. It should further be appreciated that though the originating and destination facsimile apparatus have capability to perform identical functions, the process of checking the integrity of a transmitted document is undertaken by a destination facsimile apparatus. Therefore, in the preferred embodiment of the present invention, facsimile apparatuses 220 and 270 undertake such an integrity checking process as illustrated in detail by FIG. 3A.

Continuing to refer to FIG. 3A, integrity check of a document received by a recipient at a destination device, such as facsimile apparatus 361, is made by decrypting the encrypted checksum and comparing this decrypted checksum with a checksum of the document received by facsimile apparatus 361. In the event of a mismatch, a portion of the document received by facsimile apparatus is clearly marked to denote that the received document has been tampered with.

FIG. 3B illustrates a process overflow for security verification of a document received by a computer system which includes a facsimile communication system and related software. Digital data transmitted by an originating device, such as facsimile apparatus 210 or computer system 260, is received and stored in digital storage 392 of the computer system 391. Integrity check of a document received by a recipient at a destination device, such as computer system 391, is made by decrypting the encrypted checksum and comparing the decrypted checksum with a checksum of the data received by the computer system 391. In the event of a mismatch, data received by the computer system 391 and configured to be displayed using facsimile viewing software is clearly marked to denote that the received data has been tampered with.

In addition, a destination device, such as facsimile apparatus 270 or computer system 280 and likewise facsimile apparatus 220 or computer system 230, may be provided with additional layers of protection to permit access to a user to such devices. For example, a recipient may be required to enter a user name and password in order to access documents or data received at a destination device. These additional layers of protection may be added-on to the basic functionality of the SecureFax system of the present invention.

It is believed that the operation and construction of the present invention will be apparent from the foregoing Detailed Description. While the apparatus and method shown and described have been characterized as being preferred, it should be readily understood that various changes, modifications and enhancements could be made therein without departing from the scope of the present invention as set forth in the following claims. Accordingly, those skilled in the art should appreciate that these and other variations, additions, modifications, enhancements, et cetera, are deemed to be within the ambit of the present invention whose scope is determined solely by the following claims.

What is claimed is:

1. A method of authenticating information communicated between a first communication device and a second communication device via a communications network, comprising the steps of:
a. receiving input data and generating facsimile information in a first format by said first communication device from said input data;
b. processing said input data to compute an encrypted checksum;
c. convolving said facsimile information with said encrypted checksum data to produce convolved data;
d. decrypting, at said second communication device, said encrypted checksum;
e. computing a checksum of said input data received at said second communications device; and
f. alerting a recipient at said second communication device in the event of a mismatch between said checksum data computed in step (e) and said decrypted checksum data in step (d).

2. The method of claim 1, wherein said first communication device is a digital facsimile apparatus.

3. The method of claim 1, wherein said second communication device is a digital facsimile apparatus.

4. The method of claim 1, wherein said first communication system is a computer system comprising communication means with communication software installed on said computer system.

5. The method of claim 4, wherein a database system is communicatively coupled to said second communication device.

6. The method of claim 1, wherein said second communication system is a computer system comprising communication means with communication software installed in said computer system.

7. The method of claim 26, further comprising the step of:
configuring an e-mail system for receiving and displaying an alert message to said recipient along with said received input data.

8. A method of authenticating the originality of document transmitted by an originating device and received by a destination device through a communication network, comprising the steps of:
scanning a document, intended to be transmitted, and generating information in a first format representative of said document;
calculating an encrypted checksum for said document;
convolving information in said first format with said encrypted checksum, thereby generating data in a second format;
transmitting information in said second format by means of said communication network to said destination device;
computing a checksum of data received by said destination device;
decrypting said encrypted checksum at said destination device; and
comparing said decrypted checksum with computed checksum at said destination device in order to verify the authenticity of data received at said destination device.

9. A system for authenticating information communicated over a network, comprising:
an originating device, said originating device comprising:
means for generating data representative of data received by said originating device;
means for computing a mathematical value representing said input data;
means for encrypting said computed mathematical value, thereby generating an encrypted mathematical value;
means for convolving said representative data and said encrypted mathematical value thereby producing a convolved data;
means for communicating said convolved data to a destination device; said destination device comprising:
means for computing mathematical value of data received at said destination device;
means for decrypting said mathematical value from said convolved data;
means for comparing said decrypted mathematical value with mathematical value computed by said destination device in order to verify the authenticity of information received by said destination device; and
means for alerting a recipient at said destination device in the event of a mismatch between said decrypted checksum data and the checksum computed by the destination device.
